(19) United States
(12) Patent Application Publication
(10) Pub. No.: US 2007/0034194 A1
(43) Pub. Date: Feb. 15, 2007

(54) Cooling device for a fuel-recirculation circuit from the injection system to the tank of a motor vehicle

(76) Inventors: Roberto Defilippi, Torino (IT); Antonio Villano, Baldissero Torinese (IT)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 10/572,528

(22) PCT Filed: Sep. 17, 2004
(86) PCT No.: PCT/EP04/52222

§ 371 Date: Mar. 17, 2006

(30) Foreign Application Priority Data
Sep. 19, 2003 (IT) TO2003 A 000724

(51) Int. Cl. F02M 31/20

(52) U.S. Cl. 123/541

(57) ABSTRACT

A cooling device for a fuel-recirculation circuit from the injection system to the tank of a motor vehicle comprises a pipe, which is designed to be traversed by the fuel and comprises a side wall which has at least one internal projection obtained by plastic deformation of the side wall.

### TECHNICAL FIELD

The present invention relates to a cooling device for a fuel-recirculation circuit from the injection system to the tank of a motor vehicle.

Recently, there has been a widespread use of injection systems that enable reduced levels of consumption to be obtained but call for high values of pressure and, hence, of temperature of the fuel.

Generally, the injection systems referred to comprise pumps sized for supplying a quantity of fuel greater than the one actually used. The amount in excess is recirculated to the tank where, however, the upper limit of the input temperature of the fuel is set by current standards to a value lower than that of the output temperature from the injection system.

For this reason, a cooling device designed to dissipate the heat of the fuel is used.

### BACKGROUND ART

As is known, there exist air-cooling devices comprising a coil traversed by the fuel and a thin radiant plate, set in contact with the coil itself and having the function of increasing the dissipation of heat. In particular, the radiant plate comprises a multiplicity of fins that are half-blanked and bent outwards in order to favour heat exchange by interacting with the current of air in relative motion with respect to the vehicle.

However, the cooling devices described present the drawback of being costly in so far as the assembly of the finned radiant plate with the coil is a critical operation. Said operation can be performed by welding, with all the drawbacks typical of this technology, i.e., unreliability, high cost, need for pickling of the items, or by gluing using particular high-cost conductive resins.

Furthermore, the efficiency of the device is sensibly reduced as the speed of the vehicle decreases.

### DISCLOSURE OF INVENTION

The purpose of the present invention is to provide a cooling device for a circuit for recirculation of the fuel from an injection system to the tank of a motor vehicle that has low costs and an efficiency compatible with the limits on the maximum temperature of the fuel at input to the tank.

The purposes of the present invention are achieved via a cooling device as defined in claim 1.

### BRIEF DESCRIPTION OF THE DRAWINGS

For a better understanding of the present invention there is now described a preferred embodiment, provided purely by way of non-limiting example with reference to the annexed drawings, in which:

FIG. 1 is a plan view of a cooling device; and

FIG. 2 is a cross-sectional view of the cooling device according to the line II-II of FIG. 1.

### BEST MODE FOR CARRYING OUT THE INVENTION

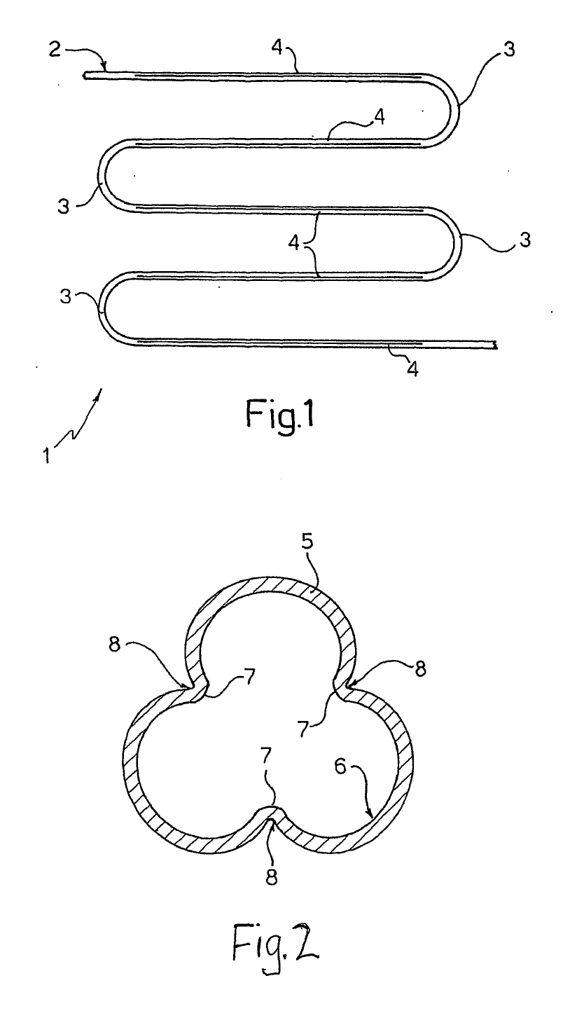

In FIG. 1, designated as a whole by 1 is a cooling device for a fuel-recirculation circuit from the injection system to the tank of a motor vehicle.

The device 1 comprises a coiled pipe 2, which includes integrally an alternating succession of elbows 3 and of rectilinear stretches 4, which have side walls 5 with substantially constant thickness and a passage section 6.

The elbows 3 have a shape of the passage section 6 that is substantially circular, whilst the shape of the passage section 6 of the stretches 4 has recesses delimited by longitudinal projections 7 of the side wall 5 facing inwards and designed to co-operate with the fuel that traverses the coiled pipe 2. On the outer surface of the side wall 5, the projections 7 define respective grooves 8 forming a clover-leafed profile of the passage section itself (FIG. 2).

The projections 7 can be either rectilinear or helical. They may moreover be obtained by plastic deformation starting from a tube with circular cross section, for example via denting with longitudinal blades.

Operation of the cooling device 1 is described in what follows. The fuel at high temperature arriving from the injection system enters the cooling device 1, dissipating, along the coiled pipe 2, its own heat to the external environment, which is at a lower temperature.

The particular configuration of the passage section 6 of the stretches 4 enables an increase in the turbulence of the motion within the pipe itself thanks to the presence of the projections 7 and thus an improvement in the convective heat exchange with the walls.

A second factor that has a favourable effect on heat exchange is represented by the fact that the passage section 6 with a clover-leafed conformation enables an increase in the mean vicinity to the walls of each particle of fuel that is inside it.

It is moreover possible to maintain the head losses between the stretches 4 and the connection pipes set upstream and downstream of the coiled pipe 2 unvaried via an appropriate sizing of the cross section 6.

From an examination of the characteristics of the cooling device 1 built according to the present invention the advantages that it makes possible are evident.

In particular, the longitudinal projections 7 can be made using reliable technologies with contained costs, moreover maintaining overall dimensions that are smaller than those of the known coiled cooling devices provided with radiant plates.

Furthermore, the efficiency of the device 1 is less sensitive to the variations in speed of the current of air in relative motion with respect to the vehicle in so far as heat exchange is to a large extent due to the turbulence generated in the flow of fuel by the projections 7.

The absence of the radiating plate connected with the pipe 2 allows the reduction of production costs and an easy production method.

Finally, it is clear that modifications and variations can be made to the cooling device 1 described and illustrated herein, without thereby departing from the sphere of protection of the present invention, as defined in the annexed claims.

1. A cooling device for a fuel-recirculation circuit from the injection system to the tank of a motor vehicle, comprising a pipe designed to be traversed by the fuel and comprising a side wall, characterized in that said side wall has at least one internal projection obtained by plastic deformation of said side wall and in that said cooling device does not comprise a radiating plate connected in a direct thermal exchange manner to said pipe.

2. The cooling device according to claim 1, characterized in that said pipe is coiled.

3. The cooling device according to claim 2, characterized in that said coiled pipe comprises an alternating succession of elbows and rectilinear stretches.

4. The cooling device according to claim 2, characterized in that it comprises a plurality of said projections.

5. The cooling device according to claim 4, characterized in that said projections are made on said rectilinear stretches.

6. The cooling device according to claim 1, characterized in that said projection or projections extend longitudinally.

7. The cooling device according to claim 1, characterized in that said side wall is entirely surrounded with a cooling current of air.
